(19) United States
(12) Patent Application Publication
(10) Pub. No.: US 2014/0280379 A1
(43) Pub. Date: Sep. 18, 2014

(54) Dynamic Element Categorization and Recombination System and Method

(71) Applicant: GREEN MOUNTAIN APPS, LLC, BURLINGTON, VT (US)

(72) Inventor: Justin William McCabe, Montpelier, VT (US)

(73) Assignee: GREEN MOUNTAIN APPS, LLC, BURLINGTON, VT (US)

(21) Appl. No.: 14/216,648

(22) Filed: Mar. 17, 2014

Related U.S. Application Data
(60) Provisional application No. 61/787,996, filed on Mar. 15, 2013.

(51) Int. Cl. G06F 17/30; G06F 3/0488

(52) U.S. Cl. CPC G06F 17/30292; G06F 3/0488
USPC 707/805

(57) ABSTRACT

Users can develop preliminary thoughts, questions, and ideas and turn them into structured plans, projects, processes, or formats for further evaluation and action by the user, or in the appropriate instance, by a person interested in the user's ideas, e.g., CTO, patent agent, investor, etc. The system and methods allow for the natural development of idea while also affording the idea to be placed into a structure without unnecessary duplication of effort. The system allows for the input, import, association, and organization, of many different types of user or automated data, the flexible organization of that data, and the characterization of that data. Characterizations may be connections between various data elements (i.e., single or grouped datum) and are relationships between the data and how it should be organized into a more structured document. The system places characterized data into a defined form at the user's request.

### RELATED APPLICATION DATA

This application claims the benefit of priority of U.S. Provisional Patent Application No. 61/787,996 filed Mar. 15, 2013, and titled Dynamic Element Categorization and Recombination System and Method.

### FIELD OF INVENTION

The present invention generally relates to the field of data management systems for personal computing devices. In particular, the present invention is directed to a Dynamic Element Categorization and Recombination System and Method.

### BACKGROUND

As people develop, enhance, and modify ideas, there are a number of traditional tools and technologies for idea management, content management, project management, and collaboration to assist them. However, many users find these solutions have limited value as they do not facilitate the nature rhythms of idea/concept development and the need to later provide a structure for defining the concept. Current tools and technologies fail to allow the idea generator to remain in the creative environment during idea development, instead forcing the idea generator into a disparate setting and requiring them to develop their ideas unnaturally.

For example, there are many project management tools than can be used to drive idea generation. These tools are often designed for a command-and-control environment characterized by written project definitions, defined roles for team members, and defined activities and tasks. However, users may find that the ideas they are working with are subject to frequent changes and relatively loose structures. When idea development is subject to changes, additions, alternatives, etc., project management tools may be more of a burden than an aid if the tools do not easily facilitate these alternatives. Moreover, these tools may inhibit the natural evolution of the idea by confining the tasks, resources, descriptions, etc., to those requested or advised by the developer of the tool.

Consequently, people may find they lack a suitable method or system with which they can flexibly, effectively, and efficiently manage the creation and development of ideas, from early incarnations to more usable, informative materials that could be used to foster, evaluate, or protect the idea.

### SUMMARY OF THE DISCLOSURE

In a first exemplary aspect, a dynamic element categorization and recombination system operating on a personal computing device having a display comprises: an input module for receiving a plurality of data placed in a free-form arrangement onto the display, a characterization module generating a characterized dataset from the plurality of data by associating a characterization value with select ones of the plurality of data; and a form module including a final structure having a plurality of categories, the form module coordinating the placement of the characterized data based upon the characterization value within at least one of the plurality of categories.

In another exemplary aspect, a system for arranging free-form data inputs from a user into a fixed-form outline, the fixed-form outline have a plurality of categories, where the system comprises: an input device for receiving a plurality of free-form data inputs; a database for receiving the plurality of free-form data inputs and a characterization value assigned to one or more of the plurality of free-form data inputs by the user, wherein the characterization value corresponds to one or more of the plurality of categories in the free-form outline; a processor in communication with the database and the fixed-form outline, the processor comparing the characterization value with at least one of the plurality of categories and generating the fixed-form outline containing one ore more of the plurality of free-form data inputs corresponding to the characterization value.

In yet another exemplary aspect, a method of dynamic element categorization and recombination of free-form data comprises: providing a personal computing device with a display; inputting data in a free-form manner onto the display; selecting a portion of the data; characterizing the data; and reformatting the data into a form, the reformatting determined based upon the characterizing.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of a dynamic element categorization and recombination system (DECRS) according to an embodiment of the present invention;

FIG. 2 is an illustration of an implementation of an input module according to an embodiment of the present invention;

FIG. 3 is a block diagram of a characterization module according to an embodiment of the present invention;

FIG. 4 is an illustration of an implementation of a form module according to an embodiment of the present invention;

FIG. 5 is a block diagram of a method of dynamically characterizing data according to an embodiment of the present invention;

FIG. 6 is a block diagram of another method of dynamically characterizing data according to an embodiment of the present invention; and

FIG. 7 is a block diagram of a computing environment that may be used to implement a DECRS according to an embodiment of the present invention.

### DESCRIPTION OF THE DISCLOSURE

The dynamic element categorization and recombination system (DECRS) of the present disclosure enables users to develop preliminary thoughts, questions, and ideas and turn them into structured plans, projects, processes, or formats for further evaluation and action by the user, or in the appropriate instance, by a person interested in the user's ideas, e.g., CTO, patent agent, investor, etc. DECRS allows for the natural development of idea while also affording the idea to be placed into a structure without unnecessary duplication of effort. As described in more detail below, a DECRS of the present disclosure allows for the input, import, association, and organization, of many different types of user or automated data. DECRS also allows for flexible organization of that data and for the characterization of that data. Characterizations may be connections between various data elements (i.e., single or grouped datum) and are relationships between the data and how it should be organized into a more structured document. DECRS places characterized data into a defined form at the user's request. The form can be either user-defined or a template provided to the user.

Turning now to the exemplary embodiments of a DECRS and with reference to FIG. 1, there is shown high level block diagram of an DECRS 100 according to an embodiment of the present invention. DECRS 100 includes an input module 104, a characterization module 108, and a form module 112.

Input module 104 facilitates the input of data that relates to information around an idea, concept, and project (hereinafter, “project”). Input module 104 allows for a user to input a free-flow of data, unencumbered by forms, required inputs, or methodical steps, also referred to herein as a free-flow arrangement or free-flow mode. For example, a user can provide a text, such as, but not limited to, a title, a date that the project was started or other development dates, a figure, a drawing, script, etc. (collectively, “data”). Any collection of data could be organized together on any page, but preferably all data relating to a single concept or idea is found on the same page or group of pages, e.g., notebook, rather than having a dispersed organization of a concept in multiple notebooks. A page can be considered to be a multi-dimensional visual space of indefinite length and width that could capture an arbitrary collection of ideas, concerns, suggestions, issues, reports, queries, plans, projects, initiatives, processes, methodologies, concepts, and other thoughts. Data could be expressed using a variety of alphanumeric characters with or without punctuation marks and other grammatical artifacts. Data can take the form of symbols (e.g., road signs, flowchart symbols, etc.), shapes (e.g., geometric, standardized, etc.), and pictures (e.g., thumbnails, photographs, etc.). Data can be placed on the computing device where the user choses and the user could freely move, modify, adapt, or commentate on any of the data placed on the device. Data on the device could have any type of relationship between other data, although preferably all data related to the same project would be stored within the same project. Input module 104 also allows a user to save and store these projects individually for retrieval, updating, and modification by the user.

The user can also drag or input indirect references to content, such as a URI or URL that is embedded within data, or content items that are referenced or made addressable using meta tags or similar mechanisms, or search results from a search engine. For example, a user who has identified a patent as prior art can hyperlink that data to the URL of the reference. Input module 104 can automatically find and associate data with other sources of information, such as by using keywords or text strings to identify possible prior art references based upon the user's inputs.

In another example, Input module 104 can provide functions (e.g., buttons, dialog boxes, etc.) embedded within a personal computing device that allow the user to find data either by direct entry of a reference to the content item (e.g., a file name), by browsing through data stores of content (e.g., file or e-mail folders, and the like), or by executing queries to databases and real-time sources of data (e.g., the internet). In another exemplary embodiment, once a user begins a project or a new project is created, input module 104 may prompt the user for some pertinent information related to the project. For example, input module 104 may offer to store a title, date of conception, proof of conception, corroboration names, and a description. While some of the areas on the screen of the tablet may be fixed sizes or responsive areas that are limited to only certain types of data input, e.g., date formats, text only, etc., the areas could also be free-form, allowing for the placement of data anywhere on the page, with the relationship between the data and its intended characterization (what it means/why it is there), which is explained in more detail below. Any requested information could be aligned with an icon, button, or other feature that would allow the user to investigate details regarding the requested information. For example, a user may not know what the definition of a conception date is, so the user can then click an icon an input module 104 can provide him this detail should he need it. Information provided by input module 104 can be in many forms, such as, text, audio, or video information.

Turning to FIG. 2, there is shown an illustration of the use of an input module 200 on a personal computing device 202. In this embodiment, personal computing device 202 is illustrated as a tablet, but it is understood that personal computing device 202 could be any other type of computing device, such as, but not limited to, a personal computer, a laptop computer, a smartphone, etc. Consistent with the discussion of input module 104 above, input module 200 facilitates the free-form input of information of a user onto the display of personal computing device 202. In the exemplary embodiment of FIG. 2, a user has input several pieces of data, at various locations on personal computing device 202. For example, the user has placed text at multiple places on personal input device 202, i.e., text 204A-C, and in varying types (e.g., compare text 204A and 204B). The user has also included multiple images or drawings 208, i.e., images 208A-B. Text 204 or images 208 may be placed anywhere on the display of personal computing device 202 and, as is currently available in the art, may be selected and moved to another location on the page as desired by the user.

Returning now to FIG. 1 and with reference to FIG. 3, at any time after the user begins entering data using input module 104 or 200, the user can begin to have the data characterized via characterization module 108. Characterization module 108 includes an identification module 116 and an assignment module 120, which, in certain embodiments, and as shown in FIG. 3, includes a key module 124.

At a high level, identification module 116 provides for the selection certain data, e.g., text 204 and/or images 208, entered by the user for the assignment of a characterization value by assignment module 120. Identification module 116 can facilitate the selection of all related data regardless of its location on the personal computing device display. Selection of user's data can occur by user defined or automated methods. User defined methods include a user pointing to the selected data using, for example, pointers, labels, encircling, or highlighting. In an exemplary embodiment, after a user enters certain data using input module 104, she then highlights an area with a chosen color of highlight that includes the data she wishes to assign a characterization value to. In this embodiment, each highlight color gets the same characterization value and in this way, a user's data can be spread out throughout a page or on multiple pages or even notebooks and be brought together later into a form or structure (described in more detail below). After highlighting, a user can continue to modify the data in the highlighted area, add to it and re-highlight the new areas of data input, highlight with multiple colors so as to allow for placement of the data in multiple locations in the form or structure, or remove highlighting using a highlight erasure tool.

Automated methods include, identification module 116 recognizing the type of data input by the user and assigning values to the data. For example, images having lead lines associated with text can be grouped together through association and connections. Identification module 116 can also assume that text placed on a page will follow an expected order of entry onto the form or structure (which can be revised and moved later by the user). In another exemplary embodiment, identification module 116 automatically partitions text and images and assignment module 120 assigns a characterization value to each of the partitions (described in more detail below). Once a characterization value is assigned by assignment module 120, a key 128 (shown described in more detail with reference to FIG. 4) is created via key module 124, which can be updated or modified by the user. For example, if two different characterization values are assigned to different data that the user wants to be coupled together, the user can adjust the characterization value such that the data has the same characterization value.

Assignment module 120 assigns a characterization value 132 to selected data so as to allow for the organized input of information into form module 112. Assignment module 120 can assign characterization value 132 based upon the selection used in identification module 116. For example, and as discussed above, if a user highlights certain data using a color highlighter, assignment module 120 can use the color designations to assign different characterization values 132.

As shown in FIG. 4, key 128 displays characterization values 132 and data 136 associated with the characterization value. Key 128 can organize characterization values 132 and data 136 in any order (as shown in FIG. 4) and can be reordered by the user. Key 128 can be pre-defined such that next to each characterization value 128 there is a description of the type of data 136 expected. For example, characterization value 128 “4” can be pre-defined to be a first figure and characterization value “5” can be the text associated with that figure. Key 128 can also include a data type 140 that is associated with each characterization value. Data type 140 can provide guidance to the user regarding where the data will be placed by form module 112. For example, data type 140A can state “FIG. 1”, thereby indicating that characterization value 4 is currently associated with future placement in the form. This may or may not be appropriate, but can be remedied by the user by altering characterization value 132.

Data 136, characterization value 132, and data type 140 are stored in a database, and any relationships established between data, such as the relationship between a figure and the associated text of that figure, can also be stored in the database. For example, a user may determine that data 136 associated with characterization value “1” and the data associated with characterization value “4” are related and thus desire that data be organized together. In this example, the organization of key 128 can provide the means by which the user can associate the data.

After characterizing certain data 136, form module 112 can use characterization values 132 to create an organized representation of the data such as a form or template, such as, but not limited to, an invention disclosure, a patent application, and a project development document. Form module 112 can allow for the user to switch back and forth between the free-form entry facilitated by input module 104 and the organized form. In general, the form used by form module 124 has an organized format and uses characterization values 132 to place data 136 in an appropriate location in a document. For example, and using the highlighting example above, if a user characterizes certain text, form module 112 will place this text in the appropriate place in a pre-selected form or in a user-generated form. In an exemplary embodiment, if the user has input her own characterization, form module 112 may request the user to specify a location in the form.

In an exemplary embodiment, form module 112 includes pre-defined forms where each part of the form organized according to a form value or category. Form values have associated characterization values 132. Thus, after characterization module 108 is employed, form module can associated characterization values 132 with form values in the form. Not all form values need to be associated with characterization values 132 and form module 132 can flexibly allow for revisions to the associations between form values and the characterization values after the form is created. Moreover, a user may utilize form module 112 to create a form based upon her data and then enter additional data into the categories of the form. The user may the return back to the free-form input allowed by input module 104 with the additional data (added while in “form mode”) in proximity to similarly categorized data. In an exemplary embodiment, new data may be minimized or in “pop-up” form so as to preserve viewing and organization of the original free-form display of data.

The forms used by form module 112 may be updatable or modified after the creation of the form by the user and the form module may take a more proactive role in determining what data, if any, should be further included in the form. For example, form module 112 may prompt a user to describe a FIG. 1f a figure has been characterized and input into the form, but no text has been associated with the figure.

DECRS 100 can be designed and configured to allow the user to drag data between devices, e.g., from a tablet to a desktop, file system viewer, or an external or third party application (e.g., e-mail client, Web browser, etc.) that supports drag-and-drop operations.

Turning now to an exemplary process 300 of dynamic characterization and organization of free-form data, and with reference to FIGS. 1-4 and with further reference to FIG. 5, at step 304 data, previously entered by a user, is selected. Selection of data at step 304 can be accomplished using, for example, an identification module, such as identification module 116.

At step 308 the selected data is characterized. Characterization includes the assignment of a characterization value to the selected data. In an exemplary embodiment, process 300 may revolve between steps 304 and 308 so as to select and characterize data input via, for example, input module 104. In an another embodiment, at step 304, data that should be characterized differently is selected in a different way, e.g., highlighted in different color, and at step 308, each set of data that is selected differently, is assigned a different characterization value.

At step 312, a key is created corresponding to the characterization and data selected. In an exemplary embodiment, the key is a readily updatable and modifiable list that includes the characterization value, at least a partial or image of the data associated with the characterization value, and the data type or form value that will be associated with the characterization value and data. Key can allow for characterization values to be modified and refined in order to more appropriately organize data.

At step 316, a form is generated based upon the key generated in step 312. The form can be a pre-defined template or a user-generated template.

Another exemplary process, process 400, of dynamic characterization and organization of free-form data is shown in FIG. 6. Similar to process 300, process 400 includes the steps of data selection (step 304), characterization (step 308), key creation (step 312), and form generation (316).

At step 404, it is determined whether more data needs to be entered. Additional data may be required, if, for example, one or more categories within the generated form are empty. In another exemplary embodiment, additional data may be required where, for example, a figure that has been included in the form does not have any text associated with it.

In an exemplary embodiment, a user may enter data directly into the form generated at step 316 (thus, the process ends at step 412). In another exemplary embodiment, and as envisioned by process 400, if the user desires to enter more data, but wishes to use the “free-form mode” the process can continue to step 408 where the data is reverted from a “form mode” back to its free-form origins. Thereby allowing a user to us an input module, such as input module 104, to continue to add data at step 416 naturally, and newly added data would return process 400 to step 304 for selection and characterization once “form mode” was desired.

Although a tablet-type personal computing device, such as personal computing device 202, was used in the examples herein, other computing devices could be used. Such a machine/computing device is device 500 that can be used to implement a set of instructions for implementing one or more of the processes or tasks performed by a DECRS, such as DECRS 100, or process 300 or 400.

As discussed in more detail below, device 500 can include a touch-sensitive display an input device, and a transceiver. Touch-sensitive display is sometimes called a “touch screen” for convenience, and may also be known as or called a touch-sensitive display system. Touch screen can be used to display information or to provide user-interface objects (e.g., virtual (also called “soft”) control keys, such as buttons or keyboards), thereby providing an input interface and an output interface between mobile device and a user. Information displayed by touch screen can include graphics, maps, text, icons, video, and any combination thereof (collectively termed “graphics”).

The touch screen has a touch-sensitive surface, which uses a sensor or set of sensors to accepts input from the user based on haptic and/or tactile contact. The touch screen may use LCD (liquid crystal display) technology, or LPD (light emitting polymer display) technology, although other display technologies may be used in other embodiments. The touch screen can detect contact (and any movement or breaking of the contact) on the touch screen and converts the detected contact into interaction with user-interface objects (e.g., one or more soft keys, icons, web pages or images) that are displayed on the touch screen. The touch screen may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen. In an exemplary embodiment of the use of device 500, a user presses a finger to the touch screen so as to initiate contact. In alternative embodiments, a user may make contact with the touch screen using any suitable object, such as, but not limited to, a stylus.

An input device, included with device 500, can facilitate navigation among and interact with one or more user-interface objects displayed in the touch screen. In an embodiment, the input device is a click wheel that can be rotated or moved such that it can be used to select one or more user-interface objects displayed on the touch screen. In an alternative embodiment, the input device can be a virtual click wheel, which may be either an opaque or semitransparent object that appears and disappears on the touch screen display in response to user interaction with device 500.

A transceiver, included with device 500, can receive and send signals from the device. In an embodiment of device 500, the transceiver sends and receives radio frequency signals through one or more communications networks, such as network 550, and/or other computing devices. The transceiver may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, the transceiver may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Device 500 may use any of a plurality of communications standards to communicate to networks or other devices with the transceiver. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol.

Device 500 includes a processor 505 and a memory 510 that communicate with each other via a bus 515. Bus 515 may include any of several types of communication structures including, but not limited to, a memory bus, a memory controller, a peripheral bus, a local bus, and any combinations thereof, using any of a variety of architectures. Memory 510 may include various components (e.g., machine-readable media) including, but not limited to, a random access memory component (e.g, a static RAM “SRAM”, a dynamic RAM “DRAM”, etc.), a read-only component, and any combinations thereof. In one example, a basic input/output system 520 (BIOS), including basic routines that help to transfer information between elements within device 500, such as during start-up, may be stored in memory 510. Memory 510 may also include (e.g., stored on one or more machine-readable media) instructions (e.g., software) 525 embodying any one or more of the aspects and/or methodologies of the present disclosure. In another example, memory 510 may further include any number of program modules including, but not limited to, an operating system, one or more application programs, other program modules, program data, and any combinations thereof.

Device 500 may also include a storage device 530. Examples of a storage device (e.g., storage device 530) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 530 may be connected to bus 515 by an appropriate interface (not shown). Example interfaces include, but are not limited to, SCSI, advanced technology attachment (ATA), serial ATA, universal serial bus (USB), IEEE 5395 (FIREWIRE), and any combinations thereof. In one example, storage device 530 may be removably interfaced with device 500 (e.g., via an external port connector (not shown)). Particularly, storage device 530 and an associated non-transitory machine-readable medium 535 may provide nonvolatile and/or volatile storage of machine-readable instructions, data structures, program modules, and/or other data for device 500. In one example, instructions 525 may reside, completely or partially, within non-transitory machine-readable medium 535. In another example, instructions 525 may reside, completely or partially, within processor 505.

Device 500 may also include a connection to one or more systems or software modules included with DECRS. Any system or device may be interfaced to bus 515 via any of a variety of interfaces (not shown), including, but not limited to, a serial interface, a parallel interface, a game port, a USB interface, a FIREWIRE interface, a direct connection to bus 515, and any combinations thereof. Alternatively, in one example, a user of device 500 may enter commands and/or other information into device 500 via an input device (not shown). Examples of an input device include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen (as discussed above), and any combinations thereof.

A user may also input commands and/or other information to device 500 via storage device 530 (e.g., a removable disk drive, a flash drive, etc.) and/or a network interface device 545. A network interface device, such as network interface device 545, may be utilized for connecting device 500 to one or more of a variety of networks, such as network 550, and one or more remote devices 555 connected thereto. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a direct connection between two computing devices, and any combinations thereof. A network, such as network 550, may employ a wired and/or a wireless mode of communication. In general, any network topology may be used. Information (e.g., data, instructions 525, etc.) may be communicated to and/or from device 500 via network interface device 555.

Device 500 may further include a video display adapter 560 for communicating a displayable image to a display device 565. Examples of a display device 565 include, but are not limited to, a liquid crystal display (LCD), a cathode ray tube (CRT), a plasma display, and any combinations thereof.

In addition to display device 565, device 500 may include a connection to one or more other peripheral output devices including, but not limited to, an audio speaker, a printer, and any combinations thereof. Peripheral output devices may be connected to bus 515 via a peripheral interface 570. Examples of a peripheral interface include, but are not limited to, a serial port, a USB connection, a FIREWIRE connection, a parallel connection, a wireless connection, and any combinations thereof.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A dynamic element categorization and recombination system operating on a personal computing device having a display, the system comprising:
an input module for receiving a plurality of data placed in a free-form arrangement onto the display,
a characterization module generating a characterized dataset from said plurality of data by associating a characterization value with select ones of said plurality of data; and
a form module including a final structure having a plurality of categories, said form module coordinating the placement of said characterized data based upon said characterization value within at least one of said plurality of categories.

2. A dynamic element categorization and recombination system according to claim 1, wherein said input module is a touch-screen.

3. A dynamic element categorization and recombination system according to claim 1, wherein at least one of said plurality of data is a drawing.

4. A system for arranging free-form data inputs from a user into a fixed-form outline, the fixed-form outline have a plurality of categories, the system comprising:
an input device for receiving a plurality of free-form data inputs;
a database for receiving said plurality of free-form data inputs and a characterization value, wherein said characterization value is assigned to one or more of said plurality of free-form data inputs and wherein said characterization value corresponds to one or more of the plurality of categories in the fixed-form outline;
a processor in communication with said database and the fixed-form outline, said processor comparing said characterization value with at least one of the plurality of categories and generating the fixed-form outline containing one or more of said plurality of free-form data inputs corresponding to said characterization value.

5. A method of dynamic element categorization and recombination of free-form data comprising:
providing a personal computing device with a display;
inputting data in a free-form manner onto the display;
selecting a portion of the data;
characterizing the data; and
reformatting the data into a form, said reformatting determined based upon said characterizing.
